(19) United States
(12) Patent Application Publication
(10) Pub. No.: US 2026/0340071 A1
(43) Pub. Date: Oct. 29, 2026

(54) ARITHMETIC DEVICE, ARITHMETIC METHOD, AND RECORDING MEDIUM

(71) Applicant: NEC Corporation, Tokyo (JP)

(72) Inventor: Taiki MIYAGAWA, Tokyo (JP)

(73) Assignee: NEC Corporation, Tokyo (JP)

(21) Appl. No.: 19/648,018

(22) Filed: Apr. 15, 2026

(30) Foreign Application Priority Data
Apr. 22, 2025 (JP) 2025-070112

(51) Int. Cl. G06F 17/13; G06F 30/28; G06F 111/10; G06F 113/08

(52) U.S. Cl. CPC G06F 17/13; G06F 30/28; G06F 2111/10; G06F 2113/08

(57) ABSTRACT

In an arithmetic device, a basis function acquisition unit applies an input function to which a boundary condition in a desired problem is imposed, to a first model trained in a state with a predetermined constraint condition provided, to acquire a basis function system used to expand the input function. A numerical solution calculation unit calculates a numerical solution for the desired problem, according to a partial differential equation obtained by expanding the input function by using the basis function system.

### INCORPORATION BY REFERENCE

This application is based upon and claims the benefit of priority from Japanese Patent Application 2025-070112, filed on Apr. 22, 2025, the disclosure of which is incorporated herein in its entirety by reference.

### TECHNICAL FIELD

The present disclosure relates to a technique that can be used to find a solution to a functional differential equation.

### BACKGROUND ART

Techniques that can be used to find a solution to a functional differential equation have been proposed.

Specifically, for example, the following Non-patent document 1 discloses an approach of converting a functional differential equation corresponding to the input function into an approximate partial differential equation by expanding an input function with a basis function, inputting parameters included in the partial differential equation into physics-informed neural networks (PINN), and obtaining a function for approximately solving the functional differential equation.

Non-patent Document 1: Taiki Miyagawa, et. al, “Physics-informed Neural Networks for Functional Differential Equations: Cylindrical Approximation and Its Convergence Guarantees”, [online], Oct. 23, 2024, arXiv, [retrieved on Apr. 7, 2025], Internet <URL: https://arxiv.org/pdf/2410.18153>

### SUMMARY

However, according to the approach disclosed in the Non-patent Document 1, there is a disadvantage that, in a case where a complicated boundary condition that can occur in a real problem is imposed on the input function, a basis function for expanding the input function cannot be set. Therefore, according to the approach disclosed in the Non-patent Document 1, there is such a problem that it is impracticable to find a solution to a functional differential equation relevant to a problem other than a particular problem.

One object of the present disclosure is to provide an arithmetic device capable of finding solutions to functional differential equations relevant to various problems.

According to one aspect of the present disclosure, an arithmetic device includes a basis function acquisition means for acquiring a basis function system used to expand an input function to which a boundary condition in a desired problem is imposed, by applying the input function to a first model trained in a state with a predetermined constraint condition provided, and a numerical solution calculation means for calculating a numerical solution for the desired problem, according to a partial differential equation obtained by expanding the input function by using the basis function system.

According to another aspect of the present disclosure, an arithmetic method executed by a computer includes acquiring a basis function system used to expand an input function to which a boundary condition in a desired problem is imposed, by applying the input function to a first model trained in a state with a predetermined constraint condition provided, and calculating a numerical solution for the desired problem, according to a partial differential equation obtained by expanding the input function by using the basis function system.

According to still another aspect of the present disclosure, a recording medium records a program for causing a computer to execute a process including acquiring a basis function system used to expand an input function to which a boundary condition in a desired problem is imposed, by applying the input function to a first model trained in a state with a predetermined constraint condition provided, and calculating a numerical solution for the desired problem, according to a partial differential equation obtained by expanding the input function by using the basis function system.

According to the present disclosure, solutions to functional differential equations relevant to various problems can be found.

### BRIEF DESCRIPTION OF THE DRAWINGS

FIG. 1 is a diagram illustrating a schematic configuration of an information processing device according to the present disclosure;

FIG. 2 is a block diagram illustrating an example of a hardware configuration of the information processing device according to the present disclosure;

FIG. 3 is a block diagram illustrating an example of a functional configuration of the information processing device according to the present disclosure;

FIG. 4 is a flowchart illustrating an example of a process performed in the information processing device according to the present disclosure;

FIG. 5 is a diagram illustrating an example of a design system to which the information processing device according to the present disclosure is applied;

FIG. 6 is a diagram illustrating an example of information presented as a simulation result on fluid simulation;

FIG. 7 is a block diagram illustrating an example of a functional configuration of an arithmetic device according to the present disclosure; and

FIG. 8 is a flowchart illustrating an example of a process performed in the arithmetic device according to the present disclosure.

### EXAMPLE EMBODIMENTS

Hereinafter, preferred example embodiments of the present disclosure will be described with reference to the drawings.

### [System Configuration]

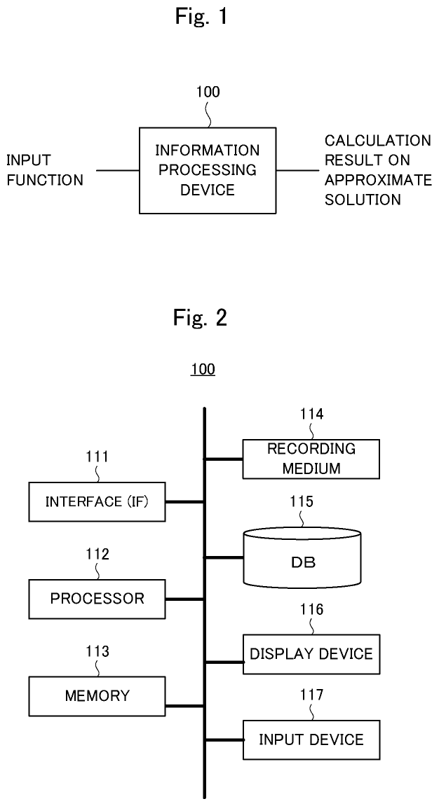

FIG. 1 is a diagram illustrating a schematic configuration of an information processing device according to the present disclosure. An information processing device 100 is configured in such a way as to output an approximate solution to a functional differential equation relevant to an input function in response to an input of the input function. The information processing device 100 has a function as an arithmetic device.

The functional differential equation can be set as a differential equation including a characteristic functional representing a characteristic of a desired problem. The functional differential equation can also be set as, for example, an equation having a form as disclosed in the Non-patent Document 1. The functional differential equation can be selected from various equations such as a Navier-Stokes-Hopf equation, a Functional Hamilton-Jacobi-Bellman equation, and a Fokker-Planck functional equation, for example. The desired problem can be selected from various problems such as a problem relating to a fluid motion, a problem relating to a game theory, and a problem relating to a field that develops in time under random forces, for example.

The input function is a function applied to the characteristic functional of the functional differential equation and can be set as a desired function to which a boundary condition in the desired problem is imposed. In the present disclosure, the “input function” can be rephrased as a “test function”.

Meanwhile, as an approach that can be used to find a solution to the functional differential equation, for example, a finite element method, a finite difference method, a spectral method, and the like are proposed in addition to the approach disclosed in the Non-patent Document 1. However, according to these known approaches, enormous computational resources are required to find a solution to the functional differential equation relevant to the input function to which a complicated boundary condition is imposed. According to the approach disclosed in the Non-patent Document 1, computational resources required for finding a solution to the functional differential equation can be reduced, but it is impracticable to find a solution to the functional differential equation relevant to a problem other than a particular problem. On the other hand, the information processing device 100 can find solutions to functional differential equations relevant to various problems while reducing computational resources by performing a process to be described later.

### [Hardware Configuration]

FIG. 2 is a block diagram illustrating an example of a hardware configuration of the information processing device according to the present disclosure. As illustrated in FIG. 2, the information processing device 100 includes an interface (IF) 111, a processor 112, a memory 113, a recording medium 114, a database (DB) 115, a display device 116, and an input device 117.

The IF 111 has a function capable of communicating with an external device. The IF 111 receives the input function or the like, for example.

The processor 112 is a computer such as a central processing unit (CPU) and controls an entirety of the information processing device 100 by executing a program prepared in advance. For example, the processor 112 performs a process related to calculation of an approximate solution to the functional differential equation relevant to the input function, or the like.

The memory 113 includes a read only memory (ROM), a random access memory (RAM), and the like. The memory 113 is also used as a work memory during execution of various kinds of processes by the processor 112.

The recording medium 114 is a non-volatile non-transitory recording medium such as a disk-shaped recording medium or a semiconductor memory and is detachably attachable to the information processing device 100. The recording medium 114 records various kinds of programs executed by the processor 112. When the information processing device 100 executes various kinds of processes, a program recorded in the recording medium 114 is loaded into the memory 113 and executed by the processor 112.

The DB 115 stores a processing result and the like obtained by a process of the processor 112, for example.

The display device 116 includes a liquid crystal display or the like, for example. The display device 116 displays information such as a calculation result on an approximate solution to the functional differential equation relevant to the input function, as necessary.

The input device 117 includes at least one of a keyboard, a mouse, a touch panel, and the like, for example. The input device 117 instructs the processor 112 according to an operation of a user.

### [Functional Configuration]

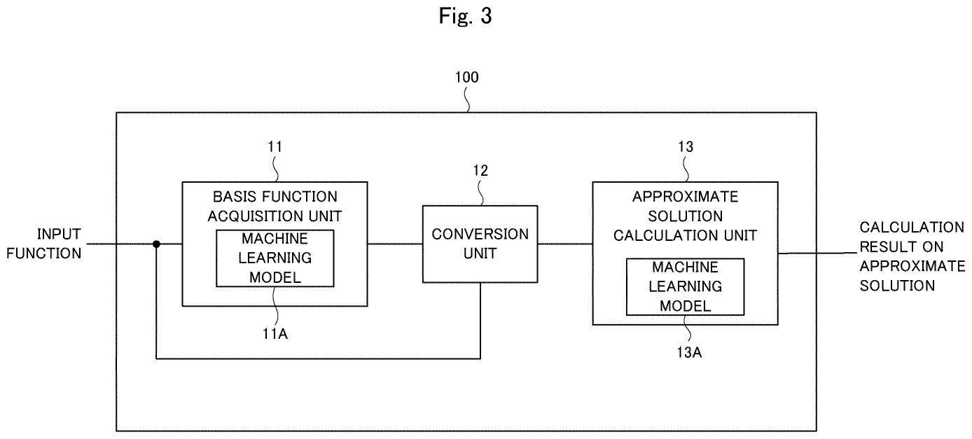

FIG. 3 is a block diagram illustrating an example of a functional configuration of the information processing device according to the present disclosure. As illustrated in FIG. 3, the information processing device 100 includes a basis function acquisition unit 11, a conversion unit 12, and an approximate solution calculation unit 13.

The basis function acquisition unit 11 has a function as a basis function acquisition means. The basis function acquisition unit 11 includes a machine learning model 11A trained in a state with a predetermined constraint condition provided. The basis function acquisition unit 11 applies the input function to the machine learning model 11A to acquire a basis function system used to expand the input function and outputs the acquired basis function system to the conversion unit 12. The machine learning model 11A can be constructed using any model such as a deep neural network (DNN) and a support vector machine (SVM), for example. A specific example of the training method for the machine learning model 11A will be described later. In the present disclosure, a case where the single machine learning model 11A is provided in the basis function acquisition unit 11 will be described unless otherwise specified.

The conversion unit 12 has a function as a conversion means. The conversion unit 12 converts the functional differential equation relevant to the input function into an approximate partial differential equation, based on a result of expanding the input function in a finite order by using the basis function system obtained from the basis function acquisition unit 11. The conversion unit 12 outputs the partial differential equation obtained by converting the input function to the approximate solution calculation unit 13.

The approximate solution calculation unit 13 has a function as a numerical solution calculation means. The approximate solution calculation unit 13 includes a trained machine learning model 13A constructed as a model including PINN. The approximate solution calculation unit 13 applies the partial differential equation obtained from the conversion unit 12 to the machine learning model 13A to acquire a function (hereinafter, also referred to as an approximation function) for approximately solving the functional differential equation relevant to the input function. The approximate solution calculation unit 13 applies the approximation function to the functional differential equation relevant to the input function to acquire a calculation result on an approximate solution to the functional differential equation and outputs the acquired calculation result on the approximate solution. The calculation result on the approximate solution output from the approximate solution calculation unit 13 may be stored in the DB 115 or displayed on the display device 116, for example. In the present disclosure, the “approximate solution” can be rephrased as a “numerical solution”.

### Specific Example

Subsequently, a specific example of a process or the like performed in the present disclosure will be described. Hereinafter, an example of a process performed in a case of finding a solution to a functional differential equation relevant to an input function θ(x) to which a boundary condition in a desired problem is imposed will be described. In the following, unless otherwise specified, a case where a process related to training of the machine learning model 11A is performed by the basis function acquisition unit 11 will be described.

The basis function acquisition unit 11 inputs a variable x of the input function θ(x) to the trained machine learning model 11A while changing the variable x to acquire a basis function system {φᵢ(x)}_{i=1, . . . , N} used to expand the input function θ(x).

The machine learning model 11A is trained in a state where a constraint condition RC1 for satisfying the boundary condition of the input function θ(x) and a constraint condition RC2 for ensuring the orthonormality of each of the N basis functions φᵢ(x) included in the basis function system {φᵢ(x)}_{i=1, . . . , N} are provided. That is, the machine learning model 11A is trained in a state with the constraint conditions RC1 and RC2 provided as predetermined constraint conditions.

The constraint condition RC1 can be set as, for example, a condition relevant to a loss L1 calculated using following Formula (1) as a loss function. The variable x^{bdy} in following Formula (1) represents a point on a boundary of the input function θ(x). The function φ_{i_bdy}(x^{bdy}) in following Formula (1) corresponds to a function representing a boundary condition of the input function θ(x). The function φ_{i_bdy}(x^{bdy}) in following Formula (1) is set as a known function relevant to the input function θ(x).

L1=|φᵢ(x^{bdy})−φ_{i_bdy}(x^{bdy})|(i=1,2, . . . N) (1)

The constraint condition RC2 can be set as, for example, a condition relevant to a loss L2 calculated using following Formula (2) as a loss function. The function w (x) in following Formula (2) represents any weight function that defines the orthonormality. The value δᵢⱼ in following Formula (2) is Kronecker delta, which is set to “1” in a case of i=j and is set to “0” in other cases.

L2=|∫dx w(x)φᵢ(x)φⱼ(x)−δᵢⱼ|(i,j=1,2, . . . ,N) (2)

At the time of training of the machine learning model 11A, the basis function acquisition unit 11 calculates the loss L1 while changing the variable x^{bdy} and the variable i in above Formula (1) and also calculates the loss L2 while changing the variable i and the variable j in above Formula (2). For example, the basis function acquisition unit 11 trains the machine learning model 11A in such a way that the total value of the loss L1 and the loss L2 approaches zero, by repeatedly calculating the loss L1 and the loss L2. According to such training, the basis function acquisition unit 11 can acquire the basis function system {φᵢ(x)}_{i=1, . . . , N} relevant to the input function θ(x), using the trained machine learning model 11A.

The conversion unit 12 converts the functional differential equation relevant to the input function θ(x) into an approximate partial differential equation, based on a result of expanding the input function θ(x) in a finite order by using N basis functions φᵢ(x) included in the basis function system {φᵢ(x)}_{i=1, . . . , N}. Specifically, the conversion unit 12 can obtain a result of expanding the input function θ(x) in a finite order by using the N basis functions φᵢ(x) included in the basis function system {φᵢ(x)}_{i=1, . . . , N} to perform, for example, a process in accordance with an approach similar to the “Cylindrical Approximation” of the Non-patent Document 1.

The approximate solution calculation unit 13 applies the partial differential equation obtained from the conversion unit 12 to the machine learning model 13A to acquire an approximation function. Specifically, the approximate solution calculation unit 13 can acquire an approximation function, for example, by inputting coefficients and variables included in the partial differential equation obtained from the conversion unit 12 into the PINN of the machine learning model 13A. The approximate solution calculation unit 13 also applies the approximation function to the functional differential equation relevant to the input function θ(x) to acquire a calculation result on an approximate solution to the functional differential equation and outputs the acquired calculation result on the approximate solution.

According to the process described above, the approximate solution calculation unit 13 can calculate a numerical solution for the desired problem, according to the partial differential equation obtained by expanding the input function θ(x) by using the basis function system {φᵢ(x)}_{i=1, . . . , N}. According to the process described above, the approximate solution calculation unit 13 can also calculate an approximate solution to the functional differential equation including a functional to which the input function θ(x) is applied, according to the partial differential equation obtained by expanding the input function θ(x) by using the basis function system {φᵢ(x)}_{i=1, . . . , N}.

According to the present specific example, the basis function acquisition unit 11 may train the machine learning model 11A in a state with a regularization term for weight attenuation or the like added to the loss L1 and the loss L2, for example.

According to the present specific example, the information processing device 100 can simultaneously or alternately perform, for example, the process related to training of the machine learning model 11A and the process related to training of the machine learning model 13A. According to the present specific example, the information processing device 100 can also perform the process related to training of the machine learning model 13A, using, for example, the basis function system output from the trained machine learning model 11A in response to an input of the input function θ(x).

For example, the machine learning model 13A is constructed as a model that receives, as inputs, a coefficient of each term in the basis function and a position of a region for which a numerical solution in the desired problem is intended to be calculated, and outputs a numerical solution at the position. The inputs of the machine learning model 13A may include, for example, a time for which a numerical solution is intended to be calculated. The machine learning model 13A is trained based on a loss L3 and a loss L4 calculated using two loss functions as indicated by following Formulas (3) and (4), for example. The loss L3 in following Formula (3) represents a residual loss value. The loss L4 in following Formula (4) represents a boundary loss value.

$$L 3 = L ( \frac{\partial f ( a , t )}{\partial t} + {\sum }_{k = 0}^{m - 1} {u}_{k} \frac{\partial f ( a , t )}{\partial {a}_{k}} ) \qquad ( 3 )$$

$$L 4 = L ( f ( a , 0 ) - {ρ}_{0} {\sum }_{k = 0}^{m - 1} {u}_{k} {a}_{k} ) \qquad ( 4 )$$

Above Formula (3) is a function representing to what degree the prediction result by the machine learning model 13A satisfies the given partial differential equation. The smaller the residual calculated as the loss L3, the more accurately the prediction result satisfies the partial differential equation. In other words, the loss L3 in above Formula (3) is a function representing the degree of satisfying the partial differential equation.

Above Formula (4) is a function representing to what degree the prediction result by the machine learning model 13A satisfies the given boundary condition or initial condition. The smaller the error calculated as the loss L4, the more accurately the prediction result satisfies the boundary condition or the initial condition. In other words, the loss L4 in above Formula (4) is a function representing the degree of satisfying the boundary condition (or the constraint condition).

Accordingly, the machine learning model 13A is a model obtained by performing learning in such a way that the loss L3 indicated by above Formula (3) and the loss L4 indicated by above Formula (4) are decreased with respect to the coefficient of each term in the input basis function and the position of the region for which a numerical solution in the desired problem is intended to be calculated.

For example, the approximate solution calculation unit 13 calculates differential values of coefficients in the loss L3 and the loss L4, based on the coefficient of each term in the basis function calculated by the machine learning model 11A, and performs training in such a way as to decrease the loss L3 and the loss L4 at the input position, using the calculated differential values. According to such training, the approximate solution calculation unit 13 can calculate a numerical solution to the differential equation.

The machine learning model 13A may be configured in such a way as to accept inputs of, for example, a value of a coefficient, a differential value of the coefficient, and a position of a region for which a numerical solution in the desired problem is intended to be calculated. Information representing the loss L3 and the loss L4 only needs to be exchanged between the basis function acquisition unit 11 and the approximate solution calculation unit 13, and the value of the coefficient of each term in the basis function may not necessarily be exchanged. That is, the information exchanged between the basis function acquisition unit 11 and the approximate solution calculation unit 13 is not limited to the example described above.

According to the present specific example, instead of the single machine learning model 11A trained in such a way as to output the basis function system {φᵢ(x)}_{i=1, . . . , N} relevant to the input function θ(x), for example, N machine learning models 11A trained in such a way as to output each of the N basis functions φᵢ(x) included in the basis function system {φᵢ(x)}_{i=1, . . . , N} may be provided in the basis function acquisition unit 11.

According to the present specific example, in a case where, for example, it is estimated that it is difficult to obtain the basis function system relevant to the input function θ(x) due to the complexity of the boundary condition or the like, the basis function acquisition unit 11 may train the machine learning model 11A in such a way as to divide the input function θ(x) into a plurality of sections and output the basis functions φᵢ(x) relevant to each of the plurality of sections.

### [Processing Flow]

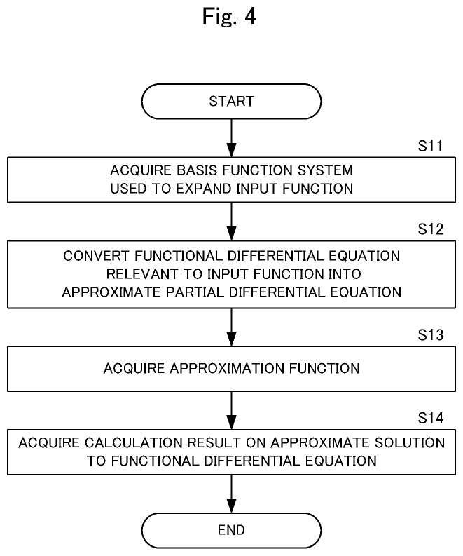

Subsequently, a flow of a process performed in the information processing device 100 will be described. FIG. 4 is a flowchart illustrating an example of a process performed in the information processing device according to the present disclosure.

First, the information processing device 100 applies an input function to the machine learning model 11A to acquire a basis function system used to expand the input function (step S11).

Next, the information processing device 100 converts a functional differential equation relevant to the input function into an approximate partial differential equation, based on a result of expanding the input function in a finite order by using the basis function system obtained in step S11 (step S12).

Subsequently, the information processing device 100 applies the partial differential equation obtained in step S12 to the machine learning model 13A to acquire an approximation function (step S13).

Finally, the information processing device 100 applies the approximation function obtained in step S13 to the functional differential equation relevant to the input function to acquire a calculation result on an approximate solution to the functional differential equation and outputs the acquired calculation result on the approximate solution (step S14).

As described above, according to the present example embodiment, by applying the input function to the machine learning model 11A trained in a state with the constraint conditions RC1 and RC2 provided, the basis function system that satisfies the boundary condition of the input function and has the orthonormality can be acquired. According to the present example embodiment, an approximate partial differential equation can be acquired based on a result of expanding the input function by using the basis function system, and an approximate solution to the functional differential equation relevant to the input function can be calculated using the acquired partial differential equation. Therefore, according to the present example embodiment, solutions to functional differential equations relevant to various problems can be found.

### Application Example

The information processing device of the present disclosure can be applied to, for example, design or the like of an industrial product having a complicated shape. Specifically, the information processing device of the present disclosure can be applied to fluid simulation in order to design an airfoil or the like of an aircraft.

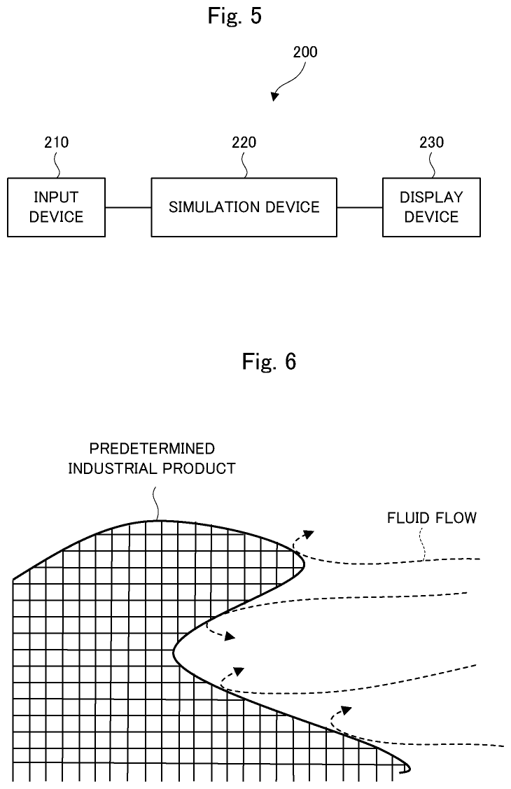

FIG. 5 is a diagram illustrating an example of a design system to which the information processing device according to the present disclosure is applied. A design system 200 includes an input device 210, a simulation device 220, and a display device 230.

The input device 210 transmits, for example, a design drawing locally or entirely illustrating the shape of a predetermined industrial product and an input function for fluid simulation in the predetermined industrial product to the simulation device 220 in response to an operation of the user. In such a case, for example, a function applied to the characteristic functional of Navier-Stokes-Hopf equation is transmitted to the simulation device 220 as an input function for fluid simulation.

The simulation device 220 has a function similar to the function of the information processing device 100. The simulation device 220 acquires a calculation result on an approximate solution to a functional differential equation relevant to the input function in response to an input of the input function for fluid simulation. The simulation device 220 superimposes visual information relevant to the calculation result on the approximate solution onto the design drawing of the predetermined industrial product to generate a display image including a result of the fluid simulation in the predetermined industrial product and transmits the generated display image to the display device 230.

FIG. 6 is a diagram illustrating an example of information presented as a simulation result on fluid simulation. The display device 230 can display an image including a simulation result as illustrated in FIG. 6, for example, as the display image received from the simulation device 220. According to the simulation result in FIG. 6, the fluid flows with respect to the predetermined industrial product are indicated by the dotted arrows. Therefore, for example, the user can examine the shape of a contact portion of the predetermined industrial product with the fluid by confirming the simulation result that changes according to the input function input to the simulation device 220.

### Second Example Embodiment

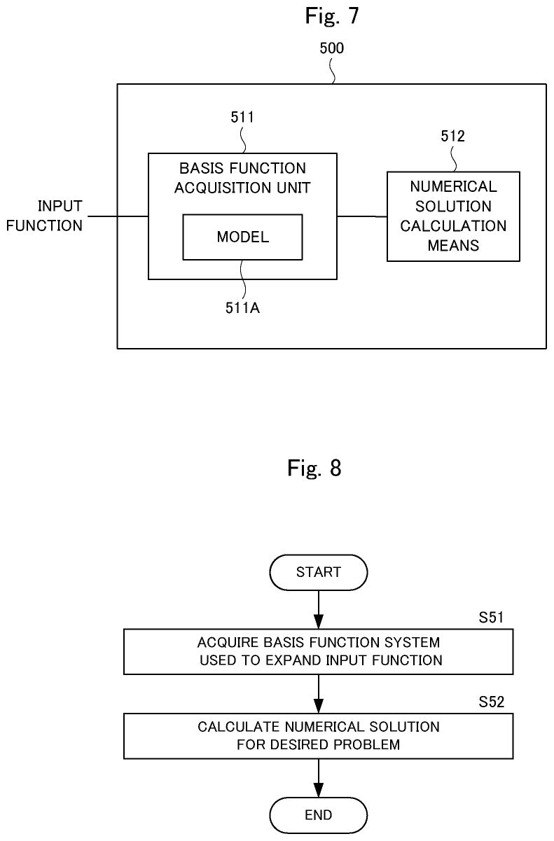

FIG. 7 is a block diagram illustrating an example of a functional configuration of an arithmetic device according to the present disclosure.

An arithmetic device 500 has a hardware configuration similar to the hardware configuration of the information processing device 100. The arithmetic device 500 includes a basis function acquisition means 511 and a numerical solution calculation means 512.

The basis function acquisition means 511 can be achieved, for example, using functions included in the basis function acquisition unit 11. The numerical solution calculation means 512 can be achieved, for example, using functions included in the approximate solution calculation unit 13.

FIG. 8 is a flowchart illustrating an example of a process performed in the arithmetic device according to the present disclosure.

The basis function acquisition means 511 applies an input function to which a boundary condition in a desired problem is imposed, to a model 511A trained in a state with a predetermined constraint condition provided, to acquire a basis function system used to expand the input function (step S51).

The numerical solution calculation means 512 calculates a numerical solution for the desired problem, according to a partial differential equation obtained by expanding the input function by using the basis function system (step S52).

According to the present example embodiment, solutions to functional differential equations relevant to various problems can be found.

Some or all of the above example embodiments may also be described as the following Supplementary Notes, but are not limited to the following.

### (Supplementary Note 1)

An arithmetic device including:
a basis function acquisition means for acquiring a basis function system used to expand an input function to which a boundary condition in a desired problem is imposed, by applying the input function to a first model trained in a state with a predetermined constraint condition provided; and
a numerical solution calculation means for calculating a numerical solution for the desired problem, according to a partial differential equation obtained by expanding the input function by using the basis function system.

### (Supplementary Note 2)

The arithmetic device according to Supplementary Note 1,
wherein the numerical solution calculation means calculates the numerical solution by using a loss function representing a degree of satisfying the partial differential equation and a loss function representing a degree of satisfying the constraint condition, and
wherein the loss function representing the degree of satisfying the partial differential equation and the loss function representing the degree of satisfying the constraint condition are calculated based on each coefficient in the basis function system.

### (Supplementary Note 3)

The arithmetic device according to Supplementary Note 1 or 2, wherein the first model is trained in a state where a first constraint condition for satisfying the boundary condition and a second constraint condition for ensuring orthonormality of each of basis functions included in the basis function system are provided as the predetermined constraint conditions.

### (Supplementary Note 4)

The arithmetic device according to Supplementary Note 1 or 2, further including a conversion means for converting a functional differential equation including a functional to which the input function is applied into an approximate partial differential equation, based on a result of expanding the input function in a finite order by using the basis function system,
wherein the numerical solution calculation means acquires a function for approximately solving the functional differential equation, by inputting a coefficient and a variable included in the approximate partial differential equation into a second model, and calculates the numerical solution by applying the acquired function to the functional differential equation.

### (Supplementary Note 5)

The arithmetic device according to Supplementary Note 1 or 2, wherein the desired problem is a problem relating to a fluid motion.

### (Supplementary Note 6)

The arithmetic device according to Supplementary Note 1 or 2, wherein the input function is an input function for fluid simulation in a predetermined industrial product, and
wherein the numerical solution calculation means generates an image including a result of the fluid simulation in the predetermined industrial product, based on a calculation result on the numerical solution.

### (Supplementary Note 7)

An arithmetic method executed by a computer, the arithmetic method including:
acquiring a basis function system used to expand an input function to which a boundary condition in a desired problem is imposed, by applying the input function to a first model trained in a state with a predetermined constraint condition provided; and
calculating a numerical solution for the desired problem, according to a partial differential equation obtained by expanding the input function by using the basis function system.

### (Supplementary Note 8)

A recording medium recording a program for causing a computer to execute a process including: acquiring a basis function system used to expand an input function to which a boundary condition in a desired problem is imposed, by applying the input function to a first model trained in a state with a predetermined constraint condition provided; and
calculating a numerical solution for the desired problem, according to a partial differential equation obtained by expanding the input function by using the basis function system.

Some or all of the configurations described in Supplementary Notes 2 to 6 dependent on the above-described Supplementary Note 1 can also be dependent on Supplementary Notes 7 and 8 by a dependency relationship similar to that of Supplementary Notes 2 to 6. Some or all of the configurations described as the Supplementary Notes can be similarly dependent on not only the Supplementary Notes 1, 7, and 8, but also diverse pieces of hardware and software, various recording means for recording software, or systems without departing from the above-described example embodiments.

While the present disclosure has been particularly shown and described with reference to example embodiments thereof, the present disclosure is not limited to these example embodiments and examples. It will be understood by those of ordinary skill in the art that various changes in form and details may be made therein without departing from the spirit and scope of the present disclosure as defined by the claims. And each example embodiment can be appropriately combined with other example embodiments.

### DESCRIPTION OF SYMBOLS

11 Basis function acquisition unit
11A Machine learning model
12 Conversion unit
13 Approximate solution calculation unit
13A Machine learning model
100 Information processing device

1. An arithmetic device comprising:
a memory configured to store instructions; and
one or more processors configured to execute the instructions to:
acquire a basis function system used to expand an input function to which a boundary condition in a desired problem is imposed, by applying the input function to a first model trained in a state with a predetermined constraint condition provided; and
calculate a numerical solution for the desired problem, according to a partial differential equation obtained by expanding the input function by using the basis function system.

2. The arithmetic device according to claim 1,
wherein the one or more processors calculate the numerical solution by using a loss function representing a degree of satisfying the partial differential equation and a loss function representing a degree of satisfying the constraint condition, and
wherein the loss function representing the degree of satisfying the partial differential equation and the loss function representing the degree of satisfying the constraint condition are calculated based on each coefficient in the basis function system.

3. The arithmetic device according to claim 1, wherein the first model is trained in a state where a first constraint condition for satisfying the boundary condition and a second constraint condition for ensuring orthonormality of each of basis functions included in the basis function system are provided as the predetermined constraint conditions.

4. The arithmetic device according to claim 1,
wherein the one or more processors are further configured to execute the instructions to convert a functional differential equation including a functional to which the input function is applied into an approximate partial differential equation, based on a result of expanding the input function in a finite order by using the basis function system,
wherein the one or more processors acquire a function for approximately solving the functional differential equation, by inputting a coefficient and a variable included in the approximate partial differential equation into a second model, and calculate the numerical solution by applying the acquired function to the functional differential equation.

5. The arithmetic device according to claim 1, wherein the desired problem is a problem relating to a fluid motion.

6. The arithmetic device according to claim 1,
wherein the input function is an input function for fluid simulation in a predetermined industrial product, and
wherein the one or more processors generate an image including a result of the fluid simulation in the predetermined industrial product, based on a calculation result on the numerical solution.

7. An arithmetic method executed by a computer, comprising:
acquiring a basis function system used to expand an input function to which a boundary condition in a desired problem is imposed, by applying the input function to a first model trained in a state with a predetermined constraint condition provided; and
calculating a numerical solution for the desired problem, according to a partial differential equation obtained by expanding the input function by using the basis function system.

8. A non-transitory computer-readable recording medium recording a program, the program causing a computer to execute a process comprising:
acquiring a basis function system used to expand an input function to which a boundary condition in a desired problem is imposed, by applying the input function to a first model trained in a state with a predetermined constraint condition provided; and
calculating a numerical solution for the desired problem, according to a partial differential equation obtained by expanding the input function by using the basis function system.
